(19) United States
(12) Patent Application Publication
(10) Pub. No.: US 2025/0392254 A1
(43) Pub. Date: Dec. 25, 2025

(54) Expanding Solar Panel System

(71) Applicant: Jerry Puchkoff, Boynton Beach, FL (US)

(72) Inventor: Jerry Puchkoff, Boynton Beach, FL (US)

(21) Appl. No.: 19/243,222

(22) Filed: Jun. 19, 2025

Related U.S. Application Data
(60) Provisional application No. 63/661,841, filed on Jun. 19, 2024.

(51) Int. Cl. H02S 30/20; H02S 10/12; H02S 20/10; H02S 20/22; H02S 30/10

(52) U.S. Cl. CPC H02S 30/20; H02S 10/12; H02S 30/10; H02S 20/10; H02S 20/22

(57) ABSTRACT

This utility model relates to the technical field of photovoltaic power generation, and discloses an expanding solar panel system that stores in a storage racking module, the solar panel system expands, extends from and retracts into the storage racking module. The multiple solar panels can slide out in of the storage racking module, and panels can be positioned in multiple directions when leaving the storage racking module to provide a large solar collecting surface of solar panels. The storage racking module comprises a base, multiple slots with the framework of storage racking module that the solar panels can extend from, each slot and solar panel configured to send that panel in multiple directions. The expanding solar panel system also has a solar panel on top of the storage racking module.

### TECHNICAL FIELD

The utility model relates to the technical field of photovoltaic power generation, in particular to an expanding solar power module system

### BACKGROUND

Photovoltaic power generation is a technology that uses the photovoltaic effect of a semiconductor interface to directly convert light energy into electrical energy. The solar energy power generation system mainly comprises three parts of a solar panel (assembly), a controller and an inverter, wherein the main parts are composed of electronic components. The solar panels are packaged and protected after being connected in series to form a large-area solar cell module, and then the solar cell racking module is matched with components such as a power controller and the like to form the photovoltaic power generation device.

When the photovoltaic panel is installed, the fixed support is usually adopted for erection, the on-site assembly erection is required and the size of the solar power system is confided to the surface area on which the system's base can be placed. The primary benefit of the expanding solar panel system is that it removes size limitations based on the surface area that the base can rest on.

### DISCLOSURE OF INVENTION

This utility model relates to the technical field of photovoltaic power generation, and discloses an expanding solar panel system that stores in a storage racking module, the solar panel system expands, extends, and retracts into the storage racking module. The multiple solar panels can slide out in of the storage racking module, and panels can be positioned in multiple directions when leaving the storage racking module to provide a large solar collecting surface of solar panels. The storage racking module comprises a base, multiple slots with the framework of storage racking module that the solar panels can extend from, each slot and solar panel configured to send that panel in multiple directions. The support frame of the storage racking module, which sits on top of the base, and which has four support pieces extending upwards from the four corners of the support frame, a bottom part of the support frame and attaches to a base, the top of the storage module which may include a solar panel on the top section of the storage racking module and four horizontal panels, extending to the four corners of the support frame, which act as support for the four solar panels that extend outward. This is an example of one configuration of solar panels. The expanding solar panel system also has a solar panel on top of the storage racking module.

The storage racking module, at the location where solar panels exit, has a “u” shaped half cylinder, which could be the length of the solar panel, or could be less, which a rod on the end of the solar panel that is closest to the slot in the storage racking module fits into. When the panel is extended from the storage racking system it may, through roller systems and other mechanisms move into multiple positions as it leaves the storage racking module. The solar panels can be moved out of the storage racking module either by sliding, or through the use of rollers, or other mechanisms that move objects. The large expanding panels may be supported by rods, which reach down and attach to the side of a building the solar system is installed on top of, or the supporting rods may reach down to the ground. If held on a building, the rods are held on the building by outside the building panels that are designed to hold the extended supporting rod. The rods can be at various angles and lengths. Embodiments of the system include the permanently positioned top solar panel replaced by a permanently positioned solar panel on the bottom layer, having a rotating base (which could be of any size, that allows the system to follow the sun), articulation methods for the individual panels, configurations where the solar panels do not extend 100% from the storage racking module, wind turbines that can be added to the solar panels, and additional support for the solar panels from the storage racking module when the solar panels are extended.

The solar panels can also be ground mounted, where the size of the solar panel field is unlimited, as the storage racking structure can have many slots, and the panels can pivot after being pulled out. The solar panels are supported when extended from the racking device first by a “u” shaped channel into which a rod attached to the side of the panel that is closest to the racking structure, and which connects to a channel in the racking structure in the slot the solar panel was stored in. The solar panels, secondly by support rods that attach to the side of the building the racking structures sits on or to the ground if the racking structure sits on the ground. Aiming at the defects of the prior art, one embodiment of the utility model provides a expanding solar panel system, which solves the problem of providing more solar panel coverage than is dictated by the size of the location where the expanding solar panel system is placed or positioned. Solar panels may also have wind turbines added.

When the solar panels are expanded, the solar panels may be moved through roller systems and other mechanisms into multiple positions as it leaves the storage module. The solar panels can be moved out of the storage racking module either by sliding, or through the use of rollers, or other mechanisms that move objects.

The system also includes standard photoelectric controls and hardware including a controller and an inverter, wherein the main parts are composed of electronic components. The solar cells are packaged in the support frame, or expanded from the support frame and then the solar cell module is matched with components such as a power controller and the like to form the photovoltaic power generation device.

Any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in a variety of sequences and orders while still falling within the scope of the present invention. Accordingly, it is intended that the scope of patent protection is to be defined by the issued claim(s) rather than the description set forth herein.

### Technical Description

In order to achieve the above purpose, the present invention provides the following technical solutions: a storage racking module with multiple slots that allows for multiple solar panels to slide in and out of the storage module, each solar panel and slot configured to allow the solar panel to move in multiple directions, once out of the storage module, the panels can move in and out and turn, so that the moveable solar panels can be deployed wherever desired. The solar panel system storage racking module comprises a base, multiple layers of slots, each slot for one solar panel, and a solar panel which sits on top of the storage module. The large solar panels when deployed are supported by rods, or other means which reach down from the outer edges of the solar panels and attach to a building, or in other cases are supported by rods that reach the ground. Embodiments of the system include having the permanent top solar panel replaced by a permanent solar panel on the bottom layer, having a rotating base (could be of any size) that allows the system to follow the sun, articulation methods for the individual panels, configurations where the solar panels do not extend 100% from the storage, wind turbines that can be added to the solar panels, and additional support for the solar panels from the storage racking module when the solar panels are extended.

The present invention is designed to go onto a wide variety of buildings, homes, commercial structures and can also be used on other equipment, including 10 feet by 40 feet containers, other size containers, or to simply placed on a flat ground surface.

Compared with the prior art, the expanding solar panel system provides the following beneficial effects:

1. This expanding solar panel system can greatly expand the number and size of the solar panels total coverage in any given solar panel installation.

2. This expanding solar panel system can be put in the protective environment of the storage racking module when electricity is not generated, such as at night or during thunderstorms, strong winds or other adverse conditions where other solar panels could be destroyed.

3. The storage racking module also acts as support for the end of the solar panels in or near the storage racking module, when the solar panels are expanded outward.

4. The horizontal solar panels when they are in the slots of the storage racking module also provide stability to the support frame

### BRIEF DESCRIPTION OF DRAWINGS

FIG. 1 shows the container before solar panel rack is loaded on top and the solar panel rack.

FIG. 2 shows a forklifting the solar panel rack prior to sitting it on top.

FIG. 3 shows the forklift placing the solar panel rack on top

FIG. 4 shows the solar panel storage rack being placed on points where solar power racks sit on the 10×40 foot container.

FIG. 5 shows the rear solar panel part way out of the solar panel storage rack

FIG. 6 shows the legs o the back solar panel being swung down.

FIG. 7 shows the legs being placed on pads.

FIG. 8 shows the left side solar panel being pulled out.

FIG. 9 shows the left side solar panel being moved into position on the same height as the container.

FIG. 10 shows the angled support arm of the left solar panel being swung into position.

FIG. 11 shows the legs, on the end furthest away from the container, being swung down,

FIG. 12 shows the front solar panel being pulled into position.

FIG. 13 shows the front solar panel being moved down to the same height as the container.

FIG. 14 shows the angled support arm being swung into position.

FIG. 15 shows the legs, at the points furthest from the container beings pulled down.

FIG. 16 shows pads being placed under the legs.

FIG. 17 shows the right solar panel being pulled into position.

FIG. 18 shows the right side solar panel being in its extended position.

FIG. 19 Shows the right side panel being moved down so it the same height as the container.

FIG. 20 shows the angle support rod attached to the container.

FIG. 21 shows the legs on the edge furthest from the container being pulled into position.

FIG. 22 shows pads being placed under the legs.

FIG. 23 shows the station set fully set up, with five total solar panels.

FIG. 24 shows a sign on the solar panel storage rack.

FIG. 25 shows an embodiment that includes windmills on the top of the storage rack.

FIG. 26 shows an alternative embodiment with nine panels and electric vehicle hardware available for charging vehicles.

FIG. 27 shows the expanding solar panel system installed on a building.

### DESCRIPTION OF THE NUMBERS IN THE DRAWINGS

1. 10×40 foot container
2. Rack that holds solar panels
3. Forklift
4. Back solar panel
5. Legs that hold storage panel
6. Pads that the legs rest on
9. Left side solar panel
11. Arm swings up at an angle to support solar panel near the 10 by 40 foot container
12. Points where solar power racks sit on the 10×40 foot container
13. Front side solar panel
14. Right side solar panel
15. Arrows that show panels move downward to the level of the container top.
16. Arrows that shows the legs pivot outward from the bottom of the solar panel.
17. Arrows show the direction the braces that angle to the container move downward from the solar panel.
19. A sign that can go on the rack that holds the solar panel once they are set in place.
22. Windmills
21. Left rear solar panel
22. Left front solar panel
23. Right rear solar panel
24. Right front solar panel
25. Charging hardware for electric vehicles.
26. Middle solar panel
27. A building
28. Support rods for solar panels that attached to a building
29. Solar panel storage rack designed for buildings
30. Solar panels designed to be attached to buildings.

### DETAILED DESCRIPTION

The following description of the embodiments of the present utility model will be made clearly and completely with reference to the accompanying drawings, in which it is apparent that the embodiments described are only some embodiments of the present utility model, but not all embodiments. All other embodiments, which can be made by those skilled in the art based on the embodiments of the utility model without making any inventive effort, are intended to be within the scope of the utility model.

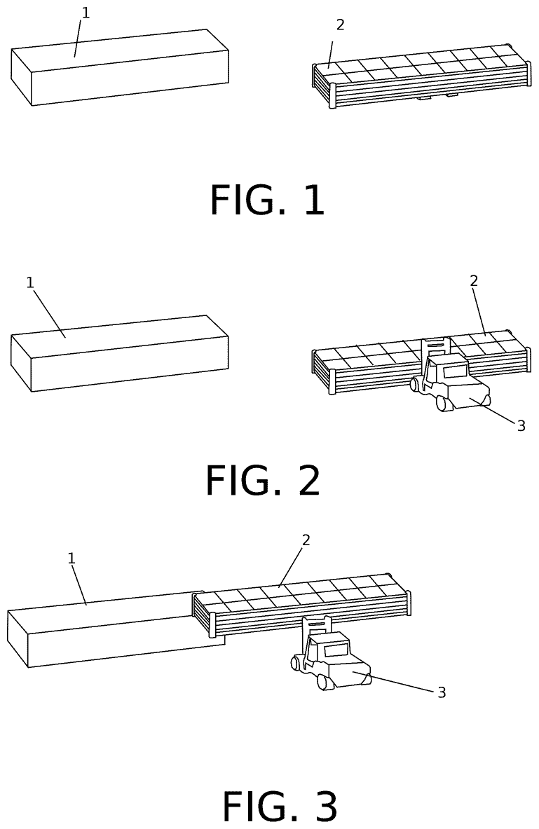

FIG. 1 shows the storage module rack 2 prior to being expanded, and the container 1 on which the storage rack will be placed. Note the unit can be of a wide variety of sizes and much larger than this figure shows. The key points in this figure are that there is a base, slots for the solar panels that expand outward, and a top solar panel. The top solar panel can also be on the bottom of the storage racking module. The bottom base may also have the ability to rotate so that it can follow the sun. This example is for illustrative purposes.

FIG. 2 shows a forklift 3 picking the solar power storage rack 2.

FIG. 3 shows the forklift 3 preparing to position the solar panel storage rack 2 on the top of the container 1.

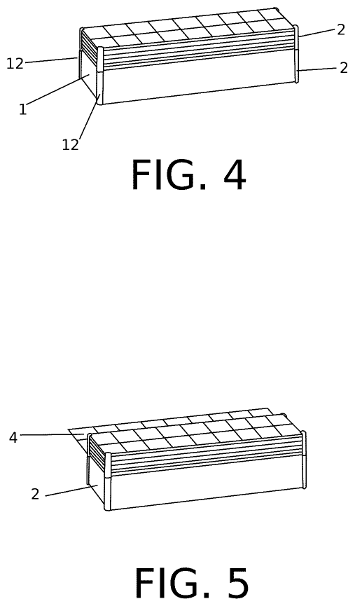

FIG. 4 shows the solar panel storage rack 2 attached to the container 1 and the proper points.

FIG. 5 shows the back solar panel 4 being pulled outward.

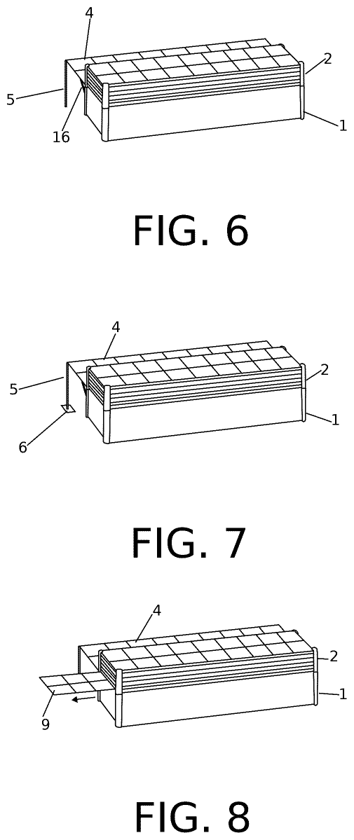

FIG. 6 shows the back solar panel 4 fully extended and the moving down so its height is equal to the container height,

FIG. 7 shows the back solar panel's 4 leg support 5 and the pad 6 the leg rests on.

FIG. 8 shows the left side solar panel 8 being moved outward to and extended position.

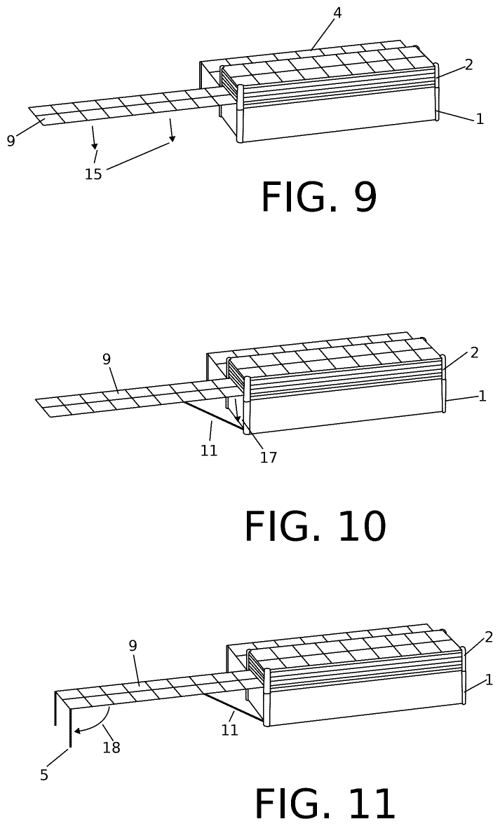

FIG. 9 shows the left solar panel 9 fully extended and being moved 15 downward to be even with the top of the container 1.

FIG. 10 shows the angular support arm 11 being slid down 17 the container 1 for support dear the container.

FIG. 11 shows the support legs 5 being moved into position 18.

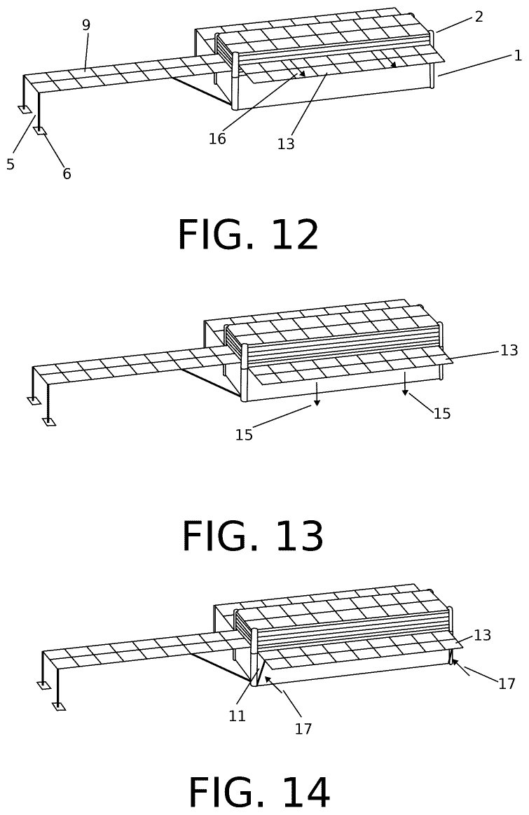

FIG. 12 shows that pads 5 have been placed on the legs and that the front solar panel is being extended into position.

FIG. 14 shows the front solar panel 13, with the angled support arm 11 moved 18 into position.

FIG. 15 shows the legs 5 being swung into position 16.

FIG. 16 shows the front support panel 13 with its legs 5 in the final position and resting on the pads 6.

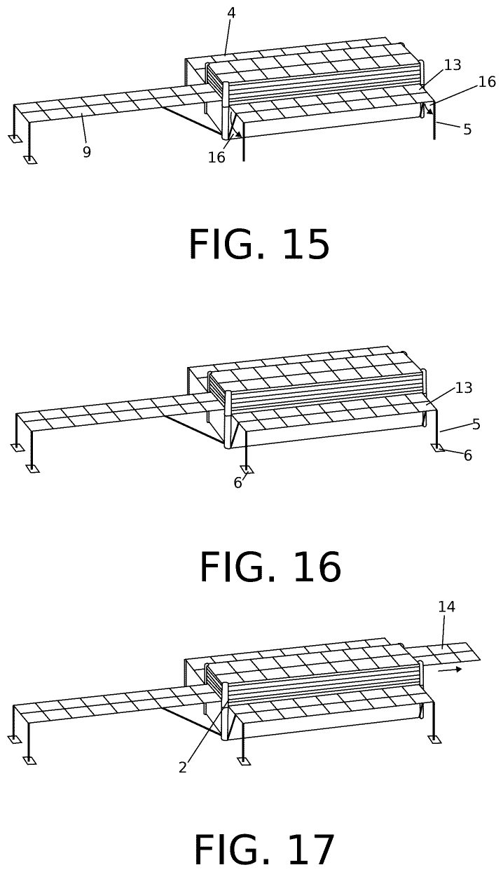

FIG. 17 shows the right side solar panel 14 being extended.

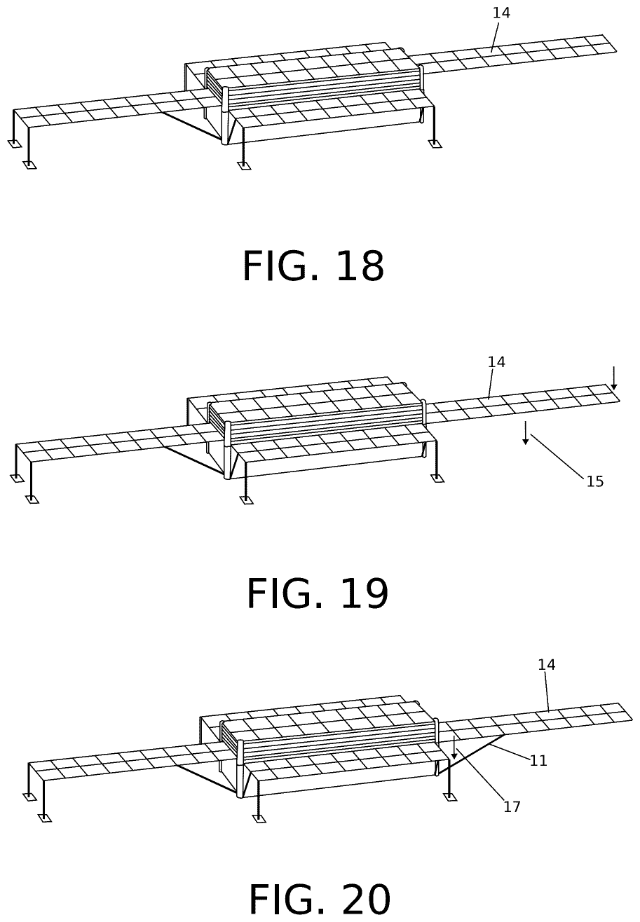

FIG. 18 shows the right side solar panel 14 fully extended.

FIG. 19 shows the right side solar panel 14 being positioned at the same height as the container.

FIG. 20 shows the angled support arm 11 being swung 17 into position.

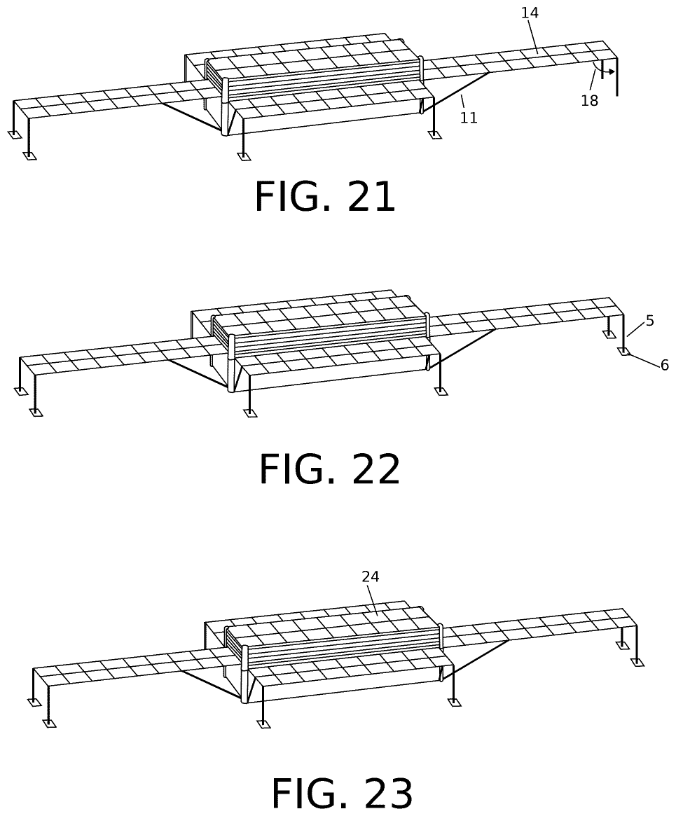

FIG. 21 shows the legs 5 of the right solar panel 14 being swung 16 into position.

FIG. 22 shows pads 6 being installed under the legs 5.

FIG. 23 shows that the middle solar panel 26 is actually on the top of solar panel rack

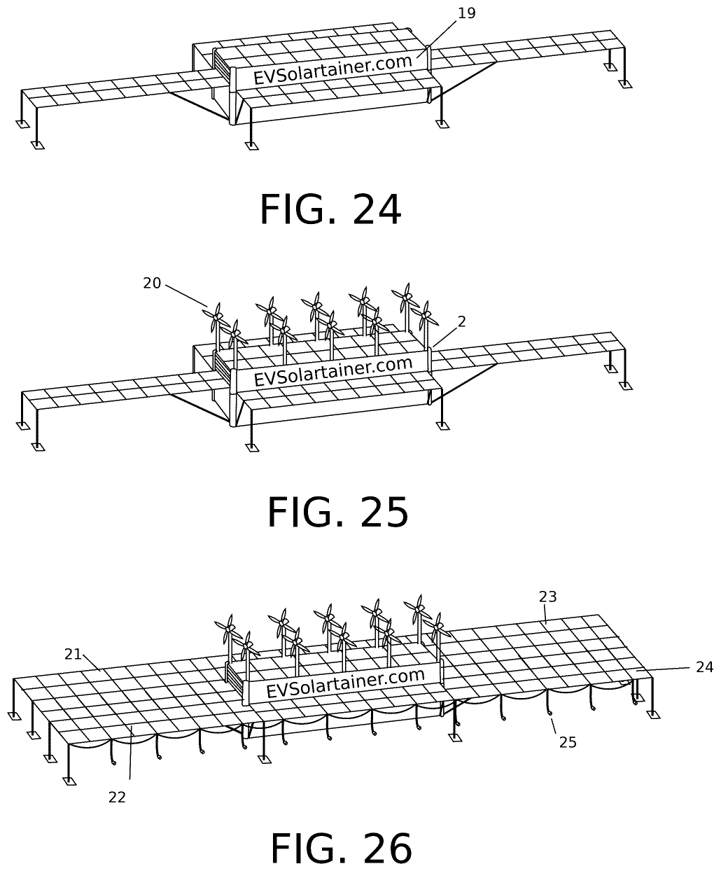

FIG. 24 shows that once the system is deployed, that a sign 19 can be placed on the solar panel storage rack.

FIG. 25 shows that small windmills 20 can also be place on the edge of the solar panel storage rack for additional power.

FIG. 26 shows how the system can be extend out even further by adding left rear solar panel 21, a left front solar panel 22, a right rear solar panel 23 and a left front solar panel 24, as well as electric vehicle charging hardware 25.

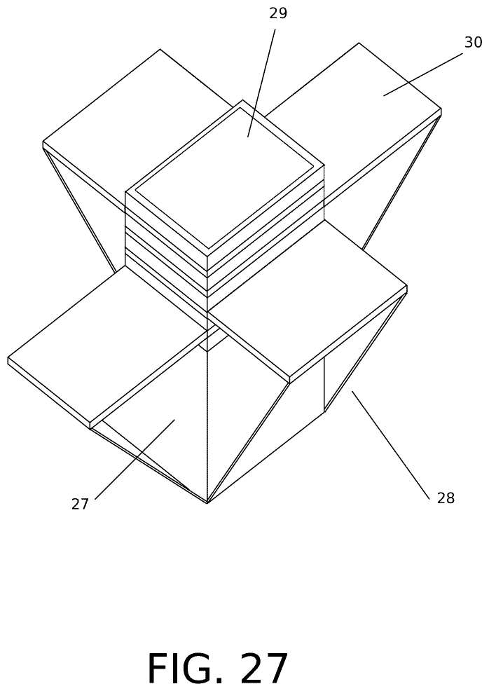

FIG. 27 shows the storage module on a building 27 with support rods 28 coming down and attaching to the building. This picture is distorted to better show the function of the unit. In reality the storage racking module of five panels will be approximately three feet high to four to four and half feet tall, and possibly much less. So it will be, in most cases, much shorter than the building or structure it is placed on. The distortion is used to show how the unit functions and how it is expanded when deployed. The figure also shows a solar panel storage rack designed for buildings 29 and solar panels designed for buildings.

### One Embodiment Commentary

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for executing the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

I claim:

1. An expandable solar panel system module comprising:
a base characterized in that: the top of the base is connected to the bottom of a support racking module;
a method connecting the base to the structure it sit upon;
a top solar panel;
the storage racking module that holds additional solar panels that expand outward;
a controller/an inverter;
solar panel installation electronic components;
the support frame comprising:
four corner support pieces extending upwards from the four corners of the bottom of support racking frame;
horizontal connecting pieces that stabilize the four corner support pieces;
a top of the storage racking module which includes a solar panel;
multiple horizontal slots, extending to the four corners of the support racking module;
each solar panel being in the bottom of a slot where an individual expanding solar panel is stored;
an inverted “u” shaped end on the solar panel that sits next to the support racking module;
wherein placing the inverted “u” shaped cylinder on the end of the solar panel into the “u” shaped half cylinder that is a part of the storage racking module will connect the solar panel to the module when extended.

2. The expanding panel system of claim 1 where the solar panels are supported by rods, which reach down and attach to the base the expandable solar panel system module is on top of, or to the ground, when the rods attach to a building.

3. The expanding solar panel system of claim 1, where the base can rotate.

4. The expanding solar panel system of claim 1, where the middle panel is position on the bottom of the support racking module.

5. The expanding solar panel system of claim 1 where the solar expanded solar panels may articulate through a tilting mechanism contained in the support storage module.

6. The expanding solar panel system of claim 1 where the solar panels can rotate up to 90 degrees away from the building or container which the storage racking module sits upon.

7. The expanding solar panel system of claim 1 where solar panels may also have wind turbines added.
